(19) United States
(12) Patent Application Publication
(10) Pub. No.: US 2025/0289114 A1
(43) Pub. Date: Sep. 18, 2025

(54) STABILIZING DEVICE FOR HOLDING A LONG HANDLE TOOL IN AN UPRIGHT POSITION

(71) Applicant: John Begin, Cambridge, NY (US)

(72) Inventor: John Begin, Cambridge, NY (US)

(21) Appl. No.: 19/079,687

(22) Filed: Mar. 14, 2025

Related U.S. Application Data
(60) Provisional application No. 63/565,856, filed on Mar. 15, 2024.

(51) Int. Cl. B25G 1/10; A46B 15/00

(52) U.S. Cl. CPC B25G 1/102; A46B 15/0097; A46B 2200/302

(57) ABSTRACT

A stabilizing device attachable to a handle of a long-handled tool includes a first angled connector and a second angled connector. Each angled connector has a slotted plate with a slotted plate edge and an axle bolt opening. Each angled connector has a U-bolt plate perpendicular to and connected to a slotted plate along the slotted plate and U-bolt plate edges. A bracket clip has finger catches extending outward from the clip edges. A spacer block is securable between the slotted plates adjacent the axle bolt openings. An axle bolt extends through the axle bolt openings and the spacer block. A support leg has a leg first end rotatably attached between the first and second angled connectors, and a leg distal end opposite the leg first end. The support leg is extendable from a first position adjacent the handle to a second position away from the handle.

### CROSS-REFERENCE TO RELATED APPLICATIONS

This application is a Utility Patent application claiming priority to U.S. Provisional Patent Application Ser. No. 63/565,856, filed on Mar. 15, 2024, which is incorporated by reference herein in its entirety.

### COPYRIGHT

A portion of the disclosure of this patent document contains material that is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

Trademarks used in the disclosure of the invention, and the applicants, make no claim to any trademarks referenced.

### BACKGROUND OF THE INVENTION

### 1) Field of the Invention

The invention relates to the field of tool accessories, and more specifically to tool accessories for use with long handle tools.

### 2) Description of Related Art

Long-handled tools are widely used in various industries and household applications for tasks such as cleaning, gardening, construction, and maintenance. These tools typically consist of an elongated handle attached to a functional end, such as a rake, broom, or shovel. While effective for their intended purposes, long-handled tools present challenges when not in active use.

During work breaks or when switching between tasks, users often face the dilemma of where to place their long-handled tools. Common practices include leaning the tool against a wall or other structure, which can lead to damage or create safety hazards. Alternatively, laying the tool on the ground requires the user to bend down to retrieve it, potentially causing strain or fatigue over time.

The lack of a dedicated storage solution for long-handled tools during brief periods of non-use can result in inefficiencies and potential safety risks in work environments. Tools left in precarious positions may fall, causing damage or injury. Additionally, repeatedly bending to pick up tools from the ground can contribute to worker fatigue and reduced productivity.

Furthermore, the diverse range of long-handled tools used across different industries and applications presents a challenge in developing a universal solution for temporary storage. Tools vary in size, weight, and handle diameter, making it difficult to create a one-size-fits-all approach to keeping them upright and readily accessible.

During regular building, grounds maintenance, and construction activities, a variety of LHT (long handle tool) push and pull tools are utilized. When an operator takes a break while working with a LHT, there is currently no provision for placing the LHT in a way that keeps it upright and ready for immediate use. The usual practice involves leaning it against another object, which might damage the surface or repeatedly bending down to pick up the tool from the ground. This not only wastes time and energy but also poses a risk of physical injury or fatigue.

The use of long handle tools in commercial and residential settings is fundamental for maintaining both interior and exterior environments. Although the long handle tools function as intended, there persists a challenge with engaging and disengaging these tools during each use.

As the use of long-handled tools continues to be prevalent in numerous sectors, there remains room for improvement in how these tools are managed during brief periods of inactivity. Addressing the challenges associated with temporary storage and accessibility of long-handled tools could potentially enhance workplace efficiency, reduce fatigue, and mitigate safety risks.

### BRIEF SUMMARY OF THE INVENTION

The instant invention in one form is directed to a device attachable to the handle of a long-handled tool. The device includes a base plate having a first wing, a second wing and a groove disposed between the first wing and the second wing. The groove extends a length of the base plate. The groove has an interior groove surface and an exterior groove surface. The device has an opening disposed in each of the first wing and the second wing. The device includes a pivot plate secured perpendicular to the exterior groove surface. The pivot plate has a pivot plate opening disposed in a central position on the pivot plate. The device includes a hub block pivotally secured to the pivot plate with a fastener. The hub block includes a cylindrical opening having an opening central axis wherein the opening central axis may be rotated about the pivot plate opening. The device includes a U-bolt having a first threaded leg, a second threaded leg parallel to the first threaded leg, and an arcuate portion connecting the first threaded leg and the second threaded leg. The device includes female threaded fasteners for engagement of each of the first threaded leg and the second threaded leg. The base plate is securable to the handle of the long-handled tool along the groove of the base plate, the U-bolt arcuate portion containing the handle against the base plate along the groove. A rod is securely insertable in the rod opening, the rod for allowing a user to position the long-handled tool on a horizontal surface with the handle in an upright position when the long-handled tool is in a resting state. The stabilizing device is an adaptable aftermarket accessory, designed for attachment to existing long handled tools (LHT), which allows these tools to be securely positioned in an upright, hands-free stance while in use.

Some examples of long-handled tools are spring leaf rake, push broom, dust mop, floor squeegee, driveway squeegee, paint rollers, magmatic sweeper, epoxy floor screed, concrete walking screed, lawn levelers, and sand rake.

One aspect is directed to a stabilizing device attachable to a handle of a long-handled tool. The stabilizing device includes a first angled connector and a second angled connector. Each of the first and second angled connectors includes a slotted plate having a slotted plate edge, an axle bolt opening and a plurality of parallel elongated slots. Each of the first and second angled connectors includes a U-bolt plate having a U-bolt plate edge coincidental with the slotted plate edge and a U-bolt opening wherein the U-bolt plate is substantially perpendicular to the slotted plate along the slotted plate edge and the U-bolt plates extend away from the opposing attachment member. The slotted plates of the first and second angled connectors are parallel and wherein the U-bolt plates of the first and second angled connectors are coplanar. The stabilizing device includes a bracket clip having opposing clip edges and a plurality of finger catches extending outward from the bracket clip edges. The plurality of finger catches are engageable with the plurality of parallel elongated slots on the slotted plates wherein the pair of opposing attachment members are secured to one another when the plurality of finger catches are fully engaged with the plurality of parallel elongated slots. The stabilizing device includes a spacer block securable between the slotted plates adjacent the axle bolt opening of each slotted plate. The stabilizing device includes an axle bolt extending through the axle bolt openings and through the spacer block wherein the spacer block is disposed between the slotted plates and an axle nut engageable to the axle bolt. The stabilizing device includes a U-bolt having a first threaded shaft, a second threaded shaft parallel to the first threaded shaft, and an arcuate portion connecting the first threaded shaft and the second threaded shaft. Female threaded fasteners may engage each of the first threaded shaft and the second threaded shaft for tightening the stabilizing device to the handle of the long-handled tool. The stabilizing device includes a support leg having a leg first end and a leg distal end opposite the leg first end. The support leg may have a leg opening proximate the leg first end, the leg opening engageable with the axle bolt. The leg is extendable from a first position wherein the leg distal end is adjacent the handle of the long-handled tool to a second position wherein the leg distal end is away from the handle of the long-handled tool. The support leg includes an angled surface disposed on the leg first end, the angled surface resting against the bracket clip when the support leg is in the extended position. The support leg is rotatably attached between the first angled connector and the second angled connector. The long-handled tool is supported upright by attaching the stabilizing device to the handle of the long-handled tool, rotating the support leg distal to the second position and setting of the leg distal end against a ground surface.

These and other objects, features, and advantages of the present invention will become more readily apparent from the attached drawings and the detailed description of the preferred embodiments, which follow.

### BRIEF DESCRIPTION OF THE DRAWINGS

A further understanding of the nature and advantages of particular embodiments may be realized by reference to the remaining portions of the specification and the drawings, in which like reference numerals are used to refer to similar components. When reference is made to a reference numeral without specification to an existing sub-label, it is intended to refer to all such multiple similar components.

FIG. 1 is a bottom left rear perspective view of the stabilizing device according to the present invention;

FIG. 2A is a top right front perspective view of the stabilizing device shown in FIG. 1;

FIG. 2B is an exploded top right front perspective view of the stabilizing device shown in FIG. 2A;

FIG. 3 is an end elevational view of the stabilizing device shown in FIG. 1;

FIG. 4 is a right side cross-sectional view of the stabilizing device attached to a handle and the stabilizing rod attached;

FIG. 5 is a perspective view of a stabilizing device attached to a long-handled tool;

FIG. 6 is an enlarged perspective view of the stabilizing device shown in FIG. 5, connected to the tool handle;

FIG. 7 is a perspective view of the stabilizing device shown in FIG. 5, from a handle side;

FIG. 8 a perspective view of the stabilizing device from an opposite side shown in FIG. 7;

FIG. 9 is a side cross sectional view of a support leg of the stabilizing device; and

FIG. 10 is an exploded view of the stabilizing device shown in FIG. 5.

Corresponding reference characters indicate corresponding parts throughout the several views. The exemplifications set out herein illustrate embodiments of the invention and such exemplifications are not to be construed as limiting the scope of the invention in any manner.

### DETAILED DESCRIPTION

While various aspects and features of certain embodiments have been summarized above, the following detailed description illustrates a few exemplary embodiments in further detail to enable one skilled in the art to practice such embodiments. The described examples are provided for illustrative purposes and are not intended to limit the scope of the invention.

In the following description, for the purposes of explanation, numerous specific details are set forth in order to provide a thorough understanding of the described embodiments. It will be apparent to one skilled in the art, however, that other embodiments of the present invention may be practiced without some of these specific details. Several embodiments are described herein, and while various features are ascribed to different embodiments, it should be appreciated that the features described with respect to one embodiment may be incorporated with other embodiments as well. By the same token however, no single feature or features of any described embodiment should be considered essential to every embodiment of the invention, as other embodiments of the invention may omit such features.

In this application the use of the singular includes the plural unless specifically stated otherwise and use of the terms “and” and “or” is equivalent to “and/or,” also referred to as “non-exclusive or” unless otherwise indicated. Moreover, the use of the term “including,” as well as other forms, such as “includes” and “included,” should be considered non-exclusive. Also, terms such as “element” or “component” encompass both elements and components including one unit and elements and components that include more than one unit, unless specifically stated otherwise.

Lastly, the terms “or” and “and/or” as used herein are to be interpreted as inclusive or meaning any one or any combination. Therefore, “A, B or C” or “A, B and/or C” mean “any of the following: A; B; C; A and B; A and C; B and C; A, B and C.” An exception to this definition will occur only when a combination of elements, functions, steps or acts are in some way inherently mutually exclusive.

As this invention is susceptible to embodiments of many different forms, it is intended that the present disclosure be considered as an example of the principles of the invention and not intended to limit the invention to the specific embodiments shown and described.

The terms long handle tool and the acronym LHT are used interchangeably to mean a tool which includes a long handle such as a rake, shovel or broom.

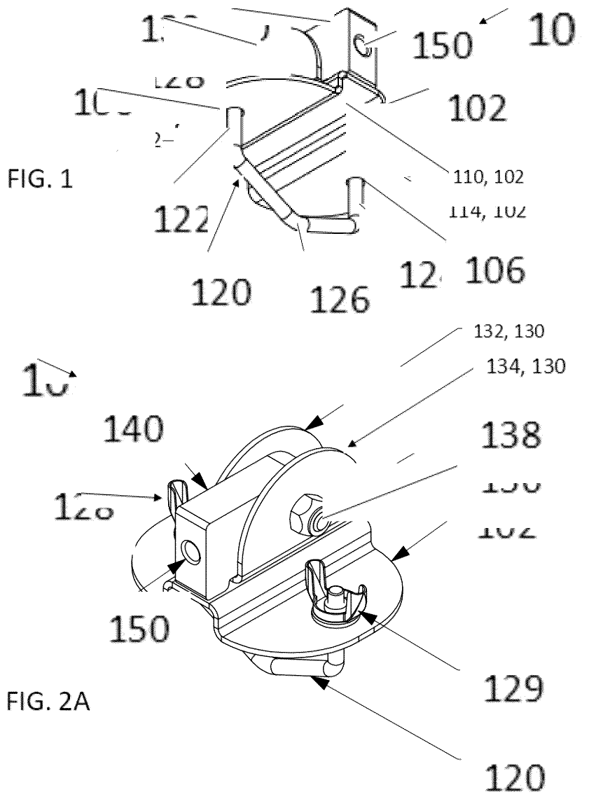

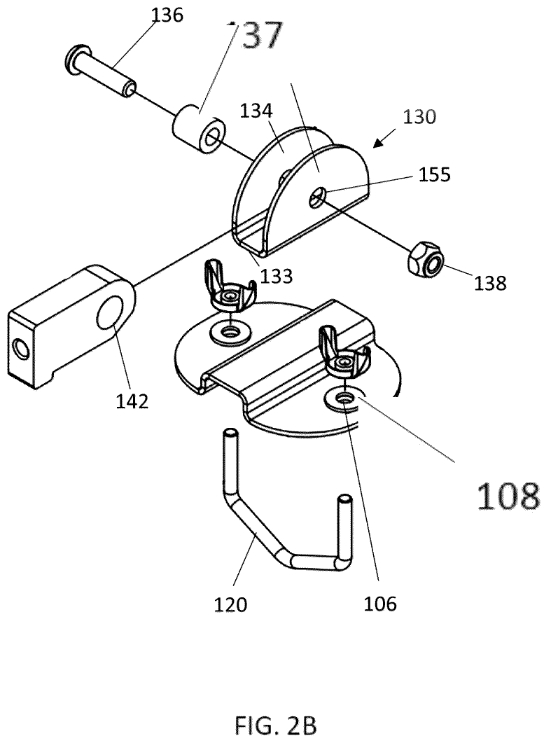

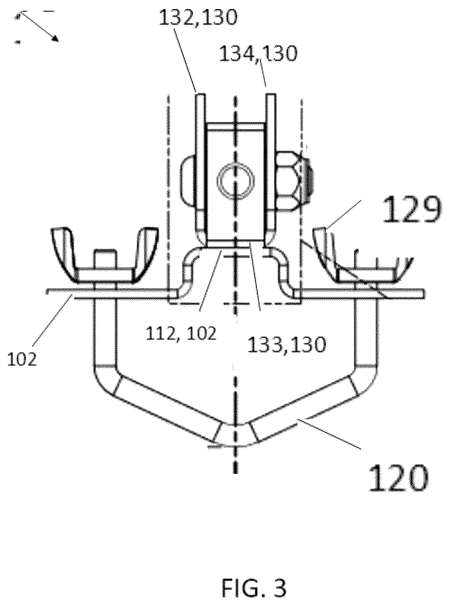

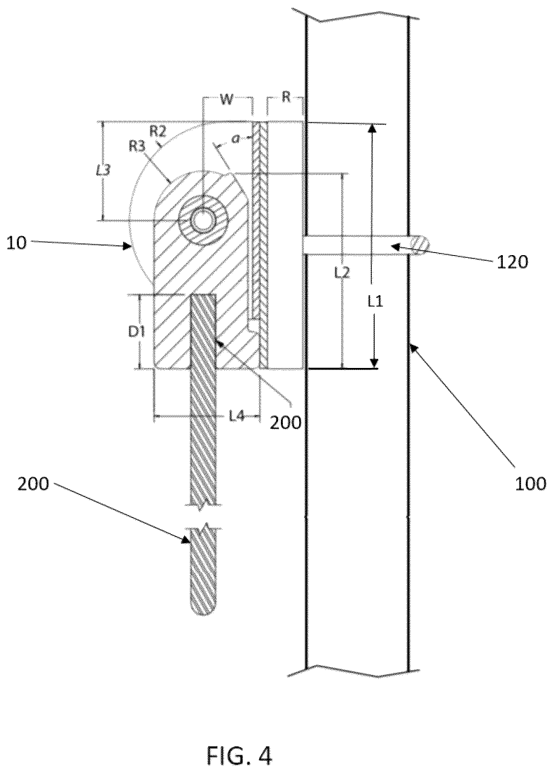

FIGS. 1, 2A, 2B and 3 show perspective, exploded and elevational views of a first embodiment of the present invention. FIG. 4 is a right side cross-sectional view of the stabilizing device 10 attached to a handle 100 and the stabilizing rod 200 attached. The dimensions given in FIG. 4 show relative dimensions including R, R2, R3, W, D1, a, and L1-L4. These dimensions may vary since many variations will work for the intended function of keeping a long-handled tool in an upright position. The stabilizing device 10 is attachable to handle 100 of a long-handled tool. The stabilizing device includes a base plate 102 having a first wing 113, a second wing 114 and a groove 110 disposed between the first wing 113 and the second wing 114. The groove extends a length L1 of the base plate 102. The groove has an interior groove surface and an exterior groove surface. The stabilizing device 10 has a bolt opening 106 disposed in each of the first wing 113 and the second wing 114. Washers 108 are disposed between the bolt openings and the first wing 113 and the second wing 114 to prevent damage to the bolt openings or to the first wing 113 and the second wing 114. The stabilizing device 10 includes a pivot plate 130 having parallel pivot ears 132, 134 secured perpendicular by a pivot plate connector 133 extending between an edge of each of the pivot ears 132, 134. The pivot plate connector is secured to the exterior groove surface. The pivot plate 130 has a pivot plate opening 155 disposed in a central position on the pivot plate ears 132, 134. The stabilizing device 10 includes a hub block 140 pivotally secured to the pivot plate 130 by a pivot opening 142 wherein an elongated fastener 136 and nut 138 extend through the pivot opening 142 and pivot plate openings 155. The hub block 140 includes a cylindrical opening 150 having an opening central axis wherein the opening central axis is rotated about a spacer tube 137 adjacent the pivot plate openings 155. The stabilizing device 10 includes a U-bolt 120 having a first threaded leg 122, a second threaded leg 124 parallel to the first threaded leg, and an arcuate portion 126 connecting the first threaded leg 122 and the second threaded leg 124. The stabilizing device 10 includes female threaded fasteners 128, 129 for engagement of each of the first threaded leg 122 and the second threaded leg 124. The base plate 102 is securable to the handle 100 of the long-handled tool along the groove 110 of the base plate 102, the U-bolt arcuate portion 126 containing the handle 100 against the base plate 102 along the groove 110. A rod 200 is securely insertable in the rod opening 150, the rod 200 for allowing a user to position the long-handled tool on a horizontal surface with the handle 100 in an upright position when the long-handled tool is in a resting state. The stabilizing device 10 alternately includes a plurality of rods extending from the hub block, the plurality of rods positioned at an acute angle from one another when in use, wherein the plurality of rods provide additional stabilization of the long-handled tool. FIG. 3 shows how the U-bolt 120 is attached to the base plate 102 using wingnuts 129.

The stabilizing device is an auxiliary support device that attaches to the long handle of a push tool such as a broom or a pull tool such as a rake. The stabilizing device is comprised of at least a leg assembly, universal mounting plate, axle bolt assembly and a U-bolt assembly.

A leg assembly is preferably a rod which is straight and more preferably a fiberglass rod with one end which press fits into a hub. A hub block which mounts directly into part of the pivot plate of the universal mounting plate via the axle bolt assembly.

The universal mounting plate-is comprised of two parts that are aligned and permanently affixed together to create the Universal Mounting Plate assembly. The base plate may be a steel zinc plate formed into a “hat” shaped profile with 2 through holes to accommodate the spacing of the U-bolt assembly. The pivot plate, may be zinc plated and formed in to a “U” shape channel with a pair of directly opposing through holes. The holes allow the axle bolt assembly to pass through capturing the hub block.

The axle bolt assembly-is comprised of a bolt, spacer tube and lock nut, this assembly connects the leg assembly to the universal mounting plate. This connection enables the leg to swing from the disengaged position to the engaged position and vice versa.

The U-bolt assembly-consists of a custom shaped length of threaded rod, 2 wingnuts and 2 washers. The threaded rod shape allows for the universal mounting plate to self-center on the handle as the wingnuts are tightened.

For installation of the stabilizing device on a handle of the long handle tool, a user positions the universal mounting plate onto the handle, aligned parallel and towards the working end or head of the tool, on its back side. A U-bolt is then placed over the handle, passes through the base plate. The U-bolt cradles the tool handle, penetrates the base plate, and is fastened securely by tightening two wing nuts, effectively clamping the universal mounting plate onto the existing tool handle. This process requires no additional tools for assembly or installation. The U-bolt assembly is versatile, accommodating tool handles of various diameters and materials, thus offering unlimited adjustability for the accessory on the tool handle.

In operation and use, the following steps provide instruction on how to use the long handle host tool with the stabilizing device installed. In an initial adjustment, with the host tool in the upright position, the two wingnuts are loosened to allow the stabilizing device to be positioned so that the tip of the support leg is 3-4″ from the end of the host tool head, tighten both wingnuts. The host tool is used as per its intended use. If needed, the stabilizing device may be readjusted on the handle to find the optimal position, both along the length and rotationally about the handle. When the operator stops using the host tool, the stabilizing device may be deployed in one of two ways. In the first, the handle is lifted and rotated sideways 180 degrees allowing gravity to swing the support leg toward the ground. In the second, with the host tool in the upright position the host tool handle is pushed directly forward, allowing gravity to swing the support leg towards the ground.

Features and benefits include:
Simplified design with just one moving component
Maintenance-free; no need for lubrication
Streamlined and compact form
Unobtrusive low profile
Lightweight for easy handling
Constructed from durable, impact-resistant, and rot-proof materials
Installation is straightforward and doesn't require tools
Quick and effortless tool-free adjustability
Universal fit for all round tool handle diameters
Compatible with various handle materials: wood, fiberglass, metal, plastic
Suitable for both indoor and outdoor applications
Applicable on a diverse range of surfaces, both hard and soft
Does not interfere with the normal function of the host tool
Helps reduce fatigue by eliminating the need to repeatedly bend over for tool retrieval
Time-saving design enhances work efficiency
Ensures the LHT stays upright and visible constantly, minimizing the risk of tripping and falling accidents.

One aspect of the invention is directed to a stabilizing device for long-handled tools. The stabilizing device provides support and stability for various types of long-handled tools when the long-handled tools is not in active use. The stabilizing device allows a long-handled tool to be maintained in an upright position without the need for external support or leaning against objects.

The stabilizing device may be constructed from durable, impact-resistant, and rot-proof materials. These material properties may contribute to the longevity and reliability of the device in various environments and conditions. The use of such materials may allow the stabilizing device to withstand repeated use and exposure to different elements. The stabilizing device may be compatible with various handle materials commonly used in long-handled tools. These materials may include wood, fiberglass, metal, and plastic. This versatility in compatibility allows the stabilizing device to be used with a wide range of existing tools without the need for specialized adaptations. The stabilizing device is suitable for both indoor and outdoor applications. This versatility allows the stabilizing device to be used in multiple contexts may enhance its utility and convenience for users across different industries or activities. Furthermore, the stabilizing device may be applicable on a diverse range of surfaces, including both hard and soft surfaces. This adaptability allows the device to function effectively on various terrains or flooring types, potentially increasing its usefulness in different work environments or scenarios.

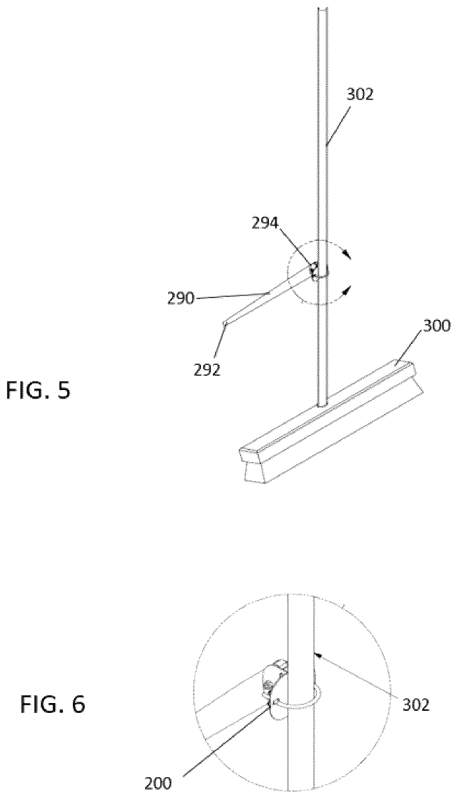

FIG. 5 shows a perspective view of a preferred embodiment of a stabilizing device 200 attached to a long-handled tool 300. The long-handle tool 300 in FIG. 6 is a push broom, but the stabilizing device 200 may be attached to any long-handle tool. The stabilizing device 200 includes the support leg 290 in an extended position whereby the long-handle tool 300 can be left upright on the ground. The distal end 292 of the support leg 290 rests on the ground and the support leg is rotatable about the support leg first end 294.

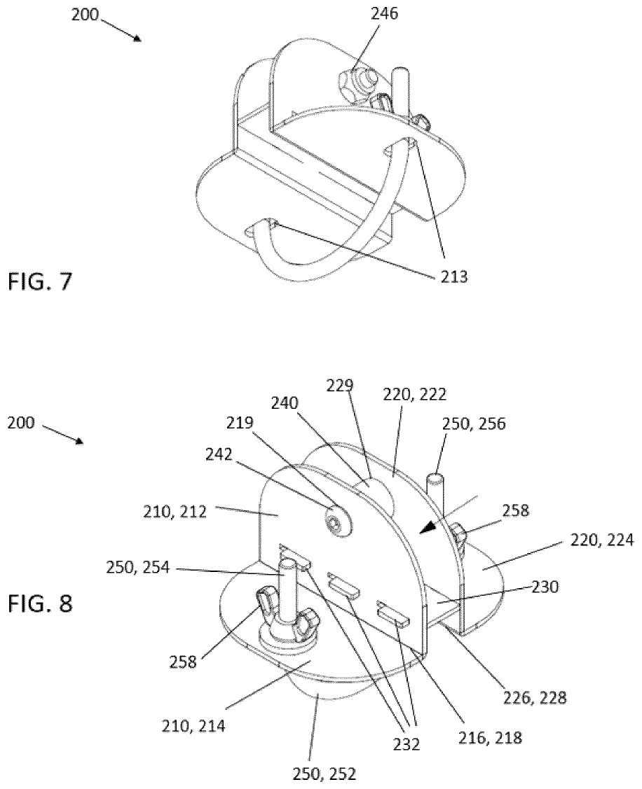

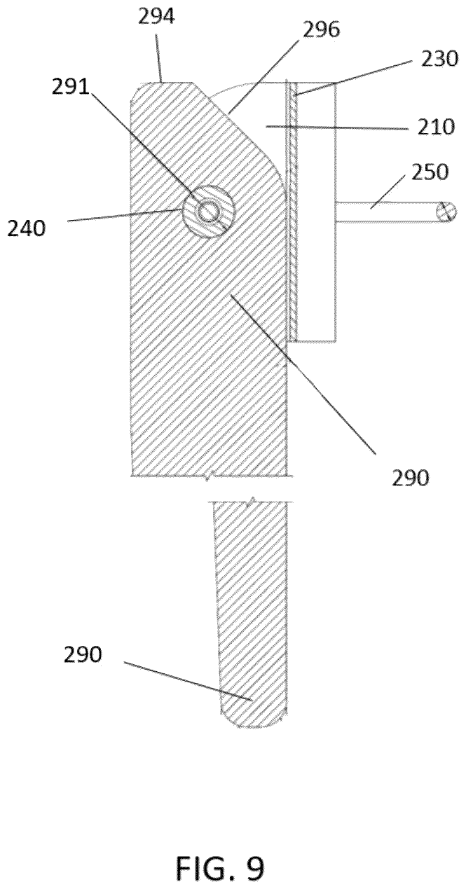

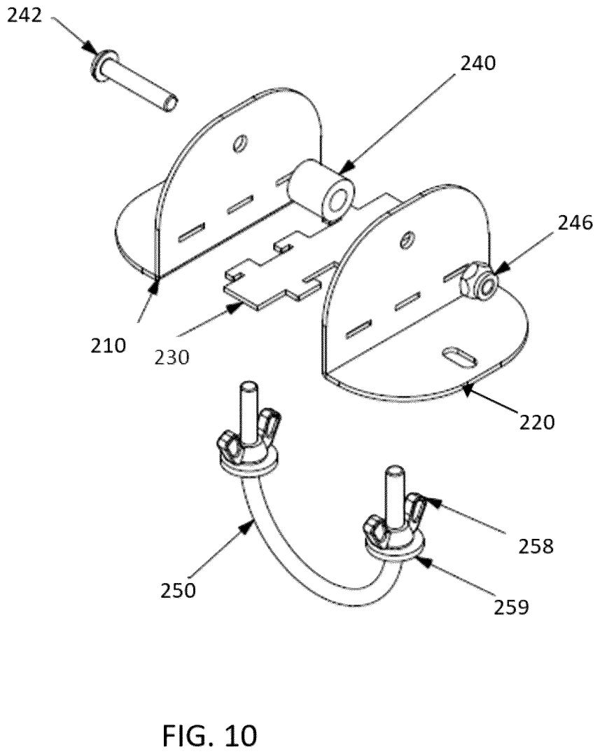

FIGS. 7 and 8 show perspective views of the stabilizing device 200. FIG. 9 is a side cross sectional view of the support leg 290 of the stabilizing device 200 and FIG. 10 is an exploded view of the stabilizing device. The stabilizing device 200 includes a first angled connector 210 and a second angled connector 220. The first angled connector 210 includes a first slotted plate 212 and a first U-bolt plate 214. The second angled connector 220 includes a second slotted plate 222 and a second U-bolt plate 224. The first slotted plate 212 includes a first slotted plate edge 216 and a first axle bolt opening 219. Similarly, the second slotted plate 222 includes a second slotted plate edge 226 and a second axle bolt opening 229. The first slotted plate 212 and the second slotted plate 222 each include a plurality of parallel elongated slots. These parallel elongated slots may be configured to provide adjustability or engagement with other components of the stabilizing device 200.

The first U-bolt plate 214 includes a first U-bolt plate edge 218, while the second U-bolt plate 224 includes a second U-bolt plate edge 228. The first U-bolt plate edge 218 is coincidental with the first slotted plate edge 216, and the second U-bolt plate edge 228 is coincidental with the second slotted plate edge 226. The first angled connector 210 and the second angled connector 220 each include a U-bolt opening 213. The U-bolt opening 213 is configured to accommodate a U-bolt for securing the stabilizing device 200 to a long-handled tool. The first U-bolt plate 214 is substantially perpendicular to the first slotted plate 212 along the first slotted plate edge 216. Similarly, the second U-bolt plate 224 is substantially perpendicular to the second slotted plate 222 along the second slotted plate edge 226. This arrangement provides structural integrity and allow for proper positioning of the stabilizing device 200 on a long-handled tool.

The first slotted plate 212 of the first angled connector 210 and the second slotted plate 222 of the second angled connector 220 are arranged parallel to each other. The first U-bolt plate 214 and the second U-bolt plate 224 are coplanar. This configuration allows the stabilizing device 200 to securely attach to a long-handled tool while maintaining proper alignment and stability. The stabilizing device 200 includes a bracket clip 230 having opposing clip edges. The bracket clip 230 includes a plurality of finger catches 232. The finger catches 232 extend outward from the opposing clip edges of the bracket clip 230.

The finger catches 232 are engageable with the plurality of parallel elongated slots on the first slotted plate 212 and the second slotted plate 222. This engagement allows the first angled connector 210 and the second angled connector 220 to be secured to one another when the finger catches 232 are fully engaged with the parallel elongated slots. The stabilizing device 200 includes a spacer block 240 securable between the first slotted plate 212 and the second slotted plate 222. The spacer block 240 is positioned adjacent to the first axle bolt opening 219 of the first slotted plate 212 and the second axle bolt opening 229 of the second slotted plate 222. The spacer block 240 contributes to the overall stability of the stabilizing device 200 by maintaining a consistent separation between the first slotted plate 212 and the second slotted plate 222. The separation may allow for proper alignment of other components within the stabilizing device 200. The bracket clip 230 with its finger catches 232 and the spacer block 240 work together to secure the first angled connector 210 and the second angled connector 220 in a stable configuration. This arrangement enhances the structural integrity of the stabilizing device 200, potentially improving its performance when attached to a long-handled tool.

The stabilizing device 200 includes an axle bolt 242 that extends through the first axle bolt opening 219 of the first slotted plate 212 and the second axle bolt opening 229 of the second slotted plate 222. The axle bolt 242 also extends through the spacer block 240, which is disposed between the first slotted plate 212 and the second slotted plate 222. An axle nut 246 is engageable with the axle bolt 242 to secure the assembly. The stabilizing device 200 also includes a U-bolt 250 for attaching the device to a long-handled tool. The U-bolt 250 includes a first threaded shaft 254 and a second threaded shaft 256. The first threaded shaft 254 and the second threaded shaft 256 are parallel to each other. An arcuate portion 252 connects the first threaded shaft 254 and the second threaded shaft 256. Female threaded fasteners 258 engage each of the first threaded shaft 254 and the second threaded shaft 256. The female threaded fasteners 258 are used for tightening the stabilizing device 200 to the handle of a long-handled tool and are preferably wing nuts to allow for toolless tightening and loosening of the stabilizing device on the long-handled tool. The U-bolt 250 may be positioned through the U-bolt opening of the first angled connector 210 and the second angled connector 220. Washers 259 are placed between the U-bolt openings and the female threaded fasteners 258 to prevent damage to the U-bolt openings or to the first and second threaded shafts 254, 256. The combination of the axle bolt 242, axle nut 246, U-bolt 250, and female threaded fasteners 258 work together to provide a secure attachment mechanism for the stabilizing device 200. The configuration allows for adjustable positioning of the stabilizing device 200 on various sizes and types of long-handled tools.

The bracket clip 230 and its finger catches 232 interact with the axle bolt 242 and U-bolt 250 assembly to provide additional stability and adjustability to the stabilizing device 200. The spacer block 240 may contribute to maintaining proper alignment and spacing between the first slotted plate 212 and the second slotted plate 222 when the axle bolt 242 is tightened. The stabilizing device 200 includes a support leg 290. In some cases, the support leg 290 may have a leg first end 294 and a leg distal end 292 opposite the leg first end 294. The support leg 290 provides stability to a long-handled tool when the stabilizing device 200 is attached to the tool and in the extended position. The support leg 290 includes a leg opening 291 proximate the leg first end 294. The leg opening 291 is engageable with the axle bolt 242 wherein the engagement allows the support leg 290 to be rotatably attached between the first angled connector 210 and the second angled connector 220. The support leg 290 is extendable from a first position to a second position. In the first position, the leg distal end 292 is adjacent to the handle of the long-handled tool. In the second position, the leg distal end 292 is positioned away from the handle of the long-handled tool. The extendable feature may allow the support leg 290 to be deployed when needed for stability and retracted when not in use. The support leg 290 may include an angled surface 296 disposed on the leg first end 294. The angled surface 296 rests against the bracket clip 230 when the support leg 290 is in the extended position. This interaction between the angled surface 296 and the bracket clip 230 help to maintain the support leg 290 in the extended position, providing stability to the long-handled tool.

As shown in FIG. 9, the support leg 290 interfaces with the first angled connector 210. The rotatable attachment of the support leg 290 between the first angled connector 210 and the second angled connector 220 allows for smooth movement between the retracted and extended positions. The engagement of the leg opening 291 with the axle bolt 242 provides a pivot point for the support leg 290. This pivot point allows the support leg 290 to rotate between its retracted and extended positions while maintaining a secure connection to the stabilizing device 200. The configuration of the support leg 290, including its rotatable attachment and extendable nature, allows the stabilizing device 200 to provide support for a long-handled tool in various situations. When extended, the support leg 290 forms a tripod-like structure with the long-handled tool, potentially increasing stability and allowing the tool to stand upright without additional support.

During installation of the stabilizing device 200 on a long-handled tool, the stabilizing device 200 is assembled and attached to a long-handled tool 300 to provide stability when the tool is not in active use. The stabilizing device 200 is installed on a handle 302 of the long-handled tool 300.

To assemble the stabilizing device 200, the first angled connector 210 and the second angled connector 220 is positioned parallel to each other. The spacer block 240 is placed between the first slotted plate 212 and the second slotted plate 222, adjacent to the first axle bolt opening 219 and the second axle bolt opening 229. The axle bolt 242 may then be inserted through these openings and the spacer block 240, and secured with the axle nut 246. The bracket clip 230 is positioned between the first angled connector 210 and the second angled connector 220. The finger catches 232 of the bracket clip 230 engage with the parallel elongated slots on the first slotted plate 212 and the second slotted plate 222, securing the components together. The support leg 290 is rotatably attached to the stabilizing device 200 by engaging the leg opening near the leg first end 294 with the axle bolt 242. This configuration allows the support leg 290 to rotate between a retracted position and an extended position.

To install the stabilizing device 200 on the long-handled tool 300, the U-bolt 250 is positioned around the handle 302. The first threaded shaft 254 and the second threaded shaft 256 of the U-bolt 250 is inserted through the U-bolt openings in the first angled connector 210 and the second angled connector 220. The female threaded fasteners 258 is then engaged with the first threaded shaft 254 and the second threaded shaft 256 to secure the stabilizing device 200 to the handle 302.

In operation, when the long-handled tool 300 is in use, the support leg 290 is kept in the retracted position, with the leg distal end 292 adjacent to the handle 302. When stability is needed, the support leg 290 is rotated to the extended position, where the leg distal end 292 is away from the handle 302. When the support leg 290 is in the extended position, the angled surface 296 on the leg first end 294 may rest against the bracket clip 230. This interaction helps maintain the support leg 290 in the extended position, providing stability to the long-handled tool 300.

To use the stabilizing device 200, a user may rotate the long-handled tool 300 to allow gravity to swing the support leg 290 towards the ground. Alternatively, with the long-handled tool 300 in an upright position, the user may push the handle 302 forward, allowing gravity to swing the support leg 290 towards the ground. Once the support leg 290 is extended, the long-handled tool 300 may be set on the ground in an upright position, supported by the combination of the handle 302 and the support leg 290.

The stabilizing device 200 may be adjusted on the handle 302 by loosening the female threaded fasteners 258, repositioning the device, and then retightening the fasteners. This adjustability allows users to optimize the position of the stabilizing device 200 for different types of long handled tools 300 or user preferences.

Since many modifications, variations, and changes in detail can be made to the described embodiments of the invention, it is intended that all matters in the foregoing description and shown in the accompanying drawings be interpreted as illustrative and not in a limiting sense. Furthermore, it is understood that any of the features presented in the embodiments may be integrated into any of the other embodiments unless explicitly stated otherwise. The scope of the invention should be determined by the appended claims and their legal equivalents.

In addition, the present invention has been described with reference to embodiments, it should be noted and understood that various modifications and variations can be crafted by those skilled in the art without departing from the scope and spirit of the invention. Accordingly, the foregoing disclosure should be interpreted as illustrative only and is not to be interpreted in a limiting sense. Further it is intended that any other embodiments of the present invention that result from any changes in application or method of use or operation, method of manufacture, shape, size, or materials which are not specified within the detailed written description or illustrations contained herein are considered within the scope of the present invention.

Insofar as the description above and the accompanying drawings disclose any additional subject matter that is not within the scope of the claims below, the inventions are not dedicated to the public and the right to file one or more applications to claim such additional inventions is reserved.

Although very narrow claims are presented herein, it should be recognized that the scope of this invention is much broader than presented by the claim. It is intended that broader claims will be submitted in an application that claims the benefit of priority from this application.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A stabilizing device attachable to a handle of a long-handled tool, comprising:
a first angled connector and a second angled connector, each angled connector including a slotted plate having a slotted plate edge and an axle bolt opening, and a U-bolt plate having a U-bolt plate edge coincidental with the slotted plate edge and a U-bolt opening, wherein the U-bolt plate is substantially perpendicular to the slotted plate along the slotted plate edge;
a bracket clip having opposing clip edges and a plurality of finger catches extending outward from the bracket clip edges;
a spacer block securable between the slotted plates adjacent the axle bolt openings;
an axle bolt extending through the axle bolt openings and the spacer block; and
a support leg having a leg first end rotatably attached between the first angled connector and the second angled connector, and a leg distal end opposite the leg first end, wherein the support leg is extendable from a first position adjacent the handle to a second position away from the handle.

2. The stabilizing device of claim 1, wherein each slotted plate includes a plurality of parallel elongated slots, and wherein the finger catches of the bracket clip are engageable with the parallel elongated slots to secure the first angled connector and the second angled connector together.

3. The stabilizing device of claim 1, further comprising a U-bolt having a first threaded shaft, a second threaded shaft parallel to the first threaded shaft, and an arcuate portion connecting the first threaded shaft and the second threaded shaft, wherein the U-bolt is configured to extend through the U-bolt openings of the first and second angled connectors.

4. The stabilizing device of claim 3, further comprising female threaded fasteners engageable with the first threaded shaft and the second threaded shaft for tightening the stabilizing device to the handle of the long-handled tool.

5. The stabilizing device of claim 1, wherein the support leg includes an angled surface disposed on the leg first end, the angled surface configured to rest against the bracket clip when the support leg is in the second position.

6. The stabilizing device of claim 1, wherein the slotted plates of the first and second angled connectors are parallel to each other, and wherein the U-bolt plates of the first and second angled connectors are coplanar.

7. The stabilizing device of claim 5, wherein the support leg includes a leg opening proximate the leg first end, the leg opening engageable with the axle bolt to rotatably attach the support leg between the first angled connector and the second angled connector.

8. A method of stabilizing a long-handled tool, comprising:
attaching a stabilizing device to a handle of the long-handled tool, the stabilizing device including a first angled connector, a second angled connector, and a support leg rotatably connected between the first and second angled connectors; and
extending the support leg from a first position adjacent the handle to a second position away from the handle, wherein the support leg in the second position forms a tripod-like structure with the long-handled tool to maintain the long-handled tool in an upright position.

9. The method of claim 8, wherein attaching the stabilizing device comprises:
securing a U-bolt around the handle of the long-handled tool; and
fastening the U-bolt to the first and second angled connectors using threaded fasteners.

10. The method of claim 9, further comprising adjusting a position of the stabilizing device along the handle by loosening the threaded fasteners, sliding the stabilizing device to a desired position, and retightening the threaded fasteners.

11. The method of claim 8, wherein extending the support leg comprises rotating the support leg about an axle bolt connecting the support leg to the first and second angled connectors.

12. The method of claim 11, wherein the support leg includes an angled surface that rests against a bracket clip of the stabilizing device when the support leg is in the second position.

13. The method of claim 8, further comprising retracting the support leg from the second position to the first position when the long-handled tool is in use.

14. The method of claim 13, wherein retracting the support leg comprises rotating the long-handled tool to allow gravity to swing the support leg towards the handle.

15. A stabilizing device attachable to a handle of a long-handled tool, the stabilizing device comprising:
a first angled connector and a second angled connector, each of the first and second angled connector including:
a slotted plate having a slotted plate edge, an axle bolt opening and a plurality of parallel elongated slots; and
a U-bolt plate having a U-bolt plate edge coincidental with the slotted plate edge and a U-bolt opening wherein the U-bolt plate is substantially perpendicular to the slotted plate along the slotted plate edge, and the U-bolt plates extend away from the opposing attachment member;
wherein the slotted plates of the first and second angled connectors are parallel and wherein the U-bolt plates of the first and second angled connectors are coplanar;
a bracket clip having opposing clip edges and a plurality of finger catches extending outward from the bracket clip edges, the plurality of finger catches engageable with the plurality of parallel elongated slots on the slotted plates wherein the pair of opposing attachment members are secured to one another when the plurality of finger catches are fully engaged with the plurality of parallel elongated slots;
a spacer block securable between the slotted plates adjacent the axle bolt opening of each slotted plate;
an axle bolt extending through the axle bolt openings and through the spacer block wherein the spacer block is disposed between the slotted plates;
an axle nut engageable to the axle bolt for tightening the slotted plates to the spacer block and the bracket clip;
a U-bolt having a first threaded shaft, a second threaded shaft parallel to the first threaded shaft, and an arcuate portion connecting the first threaded shaft and the second threaded shaft;
female threaded fasteners for engagement of each of the first threaded shaft and the second threaded shaft; and
a support leg having:
a leg first end;
a leg distal end opposite the leg first end;
a leg opening proximate the leg first end, the leg opening engageable with the axle bolt, the leg is extendable from a first position wherein the leg distal end is adjacent the handle of the long-handled tool to a second position wherein the leg distal end is away from the handle of the long-handled tool; and
an angled surface disposed on the leg first end, the angled surface resting against the bracket clip when the support leg is in the extended position;
wherein the support leg is rotatably attached between the first angled connector and the second angled connector; and
wherein the long-handled tool is supported upright by attaching the stabilizing device to the handle of the long-handled tool, rotating the support leg distal to the second position and setting of the leg distal end against a ground surface.
